(19) United States
(12) Patent Application Publication
(10) Pub. No.: US 2025/0096671 A1
(43) Pub. Date: Mar. 20, 2025

(54) ACTIVE CLAMP FLYBACK CONVERTER WITH SHUTDOWN PROTECTION

(71) Applicant: Chengdu Monolithic Power Systems Co., Ltd., Chengdu (CN)

(72) Inventors: Xiangyi Yang, Chengdu (CN); Kai Wang, Hangzhou (CN); Chanrong Jiang, Chengdu (CN)

(21) Appl. No.: 18/883,846

(22) Filed: Sep. 12, 2024

(30) Foreign Application Priority Data
Sep. 14, 2023 (CN) 202311191583.6

(51) Int. Cl. H02M 1/32; H02H 7/12; H02M 3/335

(52) U.S. Cl. CPC H02M 1/327; H02H 7/1213; H02M 3/33571; H02M 3/33592

(57) ABSTRACT

An active clamp flyback converter with shutdown protection is discussed. The active clamp flyback converter has a main power switch and an auxiliary switch integrated at a same integrated circuit. The main power switch is turned on and the auxiliary switch is turned off in response to a shutdown condition, until a current flowing through the main power switch reaches a main current limit. Then the main power switch is turned off and the auxiliary switch is turned on, until a current flowing through the auxiliary switch reaches a zero reference. Finally, the active clamp flyback converter controls the integrated circuit to enter a protection mode.

### CROSS-REFERENCE TO RELATED APPLICATIONS

This application claims priority to and the benefit of Chinese Patent Application No. 202311191583.6, filed Sep. 14, 2023, which is incorporated herein by reference in its entirety.

### BACKGROUND OF THE INVENTION

Active clamp flyback converters are widely used in galvanically isolated fields, because of the high efficiency and low EMI (electro-magnetic interference). The so-called active clamp flyback converter refers to a flyback converter that having an auxiliary switch and an absorption capacitor in the primary side besides the main power switch. As shown in FIG. 1, the active flyback converter comprises a main power switch S1 and an auxiliary switch S2, coupled to a primary winding T1 of a transformer T. The auxiliary switch S2 may be OFF during the ON duration of the main power switch S1, and may keep ON during the OFF duration of the main power switch S1, i.e., the two switches are turned on complementary. Alternatively, the auxiliary switch S2 may be OFF during the ON duration of the main power switch S1, and may be ON for a period of time during the OFF duration of the main power switch S1. When the main power switch S1 is turned off, an energy in the leakage inductance of the transformer T1 is transferred to an absorb capacitor C1. Because the auxiliary switch S2 is ON, the absorb capacitor C1 will reversely charge the leakage inductance after the current flowing through the primary side falls to zero. Thus, the energy absorbed by the absorb capacitor C1 is transferred to the leakage inductance and is released to the load, which improves the efficiency.

The main power switch S1 and the auxiliary switch S2 may be integrated into a same integrated circuit to have the circuit more compact. However, when a fault condition (e.g. over current condition) happens to one switch, substrate injection may happen in the other switch, which may affect the normal operation of the circuit and even burn the entire integrated circuit.

### SUMMARY OF THE INVENTION

In accordance with an embodiment of the present invention, an active clamp flyback converter is discussed. The active clamp flyback converter comprises: a transformer including a primary winding and a secondary winding, a main power switch, an auxiliary switch, an auxiliary capacitor, a control circuit, and a shutdown detection circuit. The primary winding is configured to receive an input voltage, and the secondary winding is configured to generate an output voltage. The main power switch is coupled between the primary winding and a primary reference ground. An electrical connection of the main power switch and the primary winding forms a switch node. The auxiliary switch and an auxiliary capacitor are coupled in series between the switch node and the input voltage. The main power switch and the auxiliary switch are integrated into a single integrated circuit. The control circuit is configured to generate a main control signal and an auxiliary control signal in response to a feedback voltage indicative of the output voltage, to respectively control the main power switch and the auxiliary switch. The shutdown detection circuit is configured to detect a shutdown condition of the active clamp flyback converter, to generate a shutdown signa. The control circuit is configured to control the main power switch to be turned on and the auxiliary switch to be turned off in response to the shutdown signal, until a current flowing through the main power switch reaches a main current limit; and then the control circuit is configured to control the auxiliary switch to be turned on and the main power switch to be turned off, until a current flowing through the auxiliary switch reaches a zero reference, to control the integrated circuit to enter a protection mode.

In addition, in accordance with an embodiment of the present invention, an integrated circuit used for an active clamp flyback converter is discussed. The integrated circuit comprises: an auxiliary switch, a main power switch, a control circuit, and a shutdown detection circuit. The main power switch is coupled between the auxiliary switch and a reference ground. The control circuit is configured to generate a main control signal and an auxiliary control signal in response to a feedback voltage indicative of an output voltage of the active clamp flyback converter, to respectively control the main power switch and the auxiliary switch. The shutdown detection circuit is configured to detect a shutdown condition of the active clamp flyback converter, to generate a shutdown signal. The control circuit is configured to control the main power switch to be turned on and the auxiliary switch to be turned off in response to the shutdown signal, until a current flowing through the main power switch reaches a main current limit; and then the control circuit is configured to control the auxiliary switch to be turned on and the main power switch to be turned off, until a current flowing through the auxiliary switch reaches a zero reference, to control the integrated circuit to enter a protection mode.

Furthermore, in accordance with an embodiment of the present invention, a control circuit used in an active clamp flyback converter is discussed. The active clamp flyback converter including a main power switch and an auxiliary switch integrated at a single integrated circuit. The control circuit comprises: a first comparator, a second comparator, and a flip flop. The first comparator is configured to compare a main sense signal indicative of a current flowing through the main power switch with a main current limit, to generate an over current signal. The second comparator, configured to compare an auxiliary sense signal indicative of a current flowing through the auxiliary switch with a zero reference, to generate a zero detect signal. The flip flop is configured to generate a main control signal and an auxiliary control signal in response to the over current signal and a shutdown signal indicative of a shutdown condition of the integrated circuit. The flip flop is configured to: control the main power switch to be turned on and the auxiliary switch to be turned off in response to the shutdown signal; and control the main power switch to be turned off and the auxiliary switch to be turned on in response to the over current signal.

### BRIEF DESCRIPTION OF DRAWINGS

FIG. 1 schematically shows a typical active clamp flyback converter in the prior art.

FIG. 2 schematically shows an active clamp flyback converter 200 in accordance with an embodiment of the present invention.

FIG. 3 schematically shows a circuit configuration of the control circuit 104 in accordance with an embodiment of the present invention.

FIG. 4 schematically shows a circuit configuration of the control circuit 104 in accordance with an embodiment of the present invention.

FIG. 5 schematically shows a circuit configuration of the control circuit 104 in accordance with an embodiment of the present invention.

FIG. 6 schematically shows an active clamp flyback converter 600 in accordance with an embodiment of the present invention.

FIG. 7 schematically shows a flowchart 700 of a method used in an active clamp flyback converter in accordance with an embodiment of the present invention.

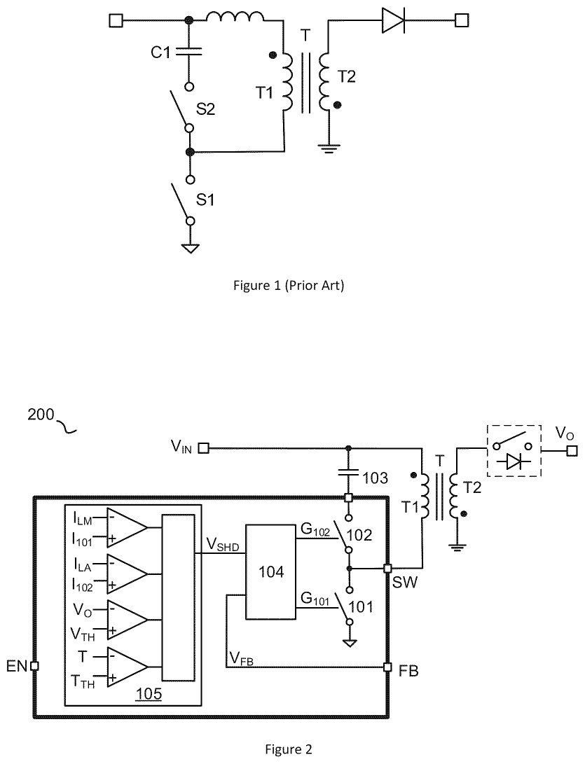

### DETAILED DESCRIPTION OF THE INVENTION

Embodiments of circuits for active clamp flyback converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 2 schematically shows an active clamp flyback converter 200 in accordance with an embodiment of the present invention. In the example of FIG. 2, the active clamp flyback converter 200 comprises: a transformer T, configured to receive an input voltage V_{IN}. The transformer T includes a primary winding T1 and a secondary winding T2. The active clamp flyback converter 200 is configured to provide an output voltage V_{O} at the secondary winding T2. The active clamp flyback converter 200 further comprises: a main power switch 101, an auxiliary switch 102, an auxiliary capacitor 103, and a control circuit 104. The main power switch 101 is coupled between the primary winding T1 and a primary reference ground. An electrical connection of the main power switch 101 and the primary winding T1 forms a switch node SW. The auxiliary switch 102 and the auxiliary capacitor 103 are coupled in series between the switch node SW and the input voltage V_{IN}. The control circuit 104 is configured to generate a main control signal G₁₀₁ and an auxiliary control signal G₁₀₂ in response to a feedback voltage V_{FB} indicative of the output voltage V_{O}, to respectively control the main power switch 101 and the auxiliary switch 102. The main power switch101 and the auxiliary switch 102 are integrated into a same integrated circuit (i.e., a same IC chip, as shown in FIG. 2 with a thick line block).

In one embodiment of the present invention, the main control signal G₁₀₁ and the auxiliary control signal G₁₀₂ may be complementary. In other embodiments of the present invention, there may exist a certain dead time between the main control signal G₁₀₁ and the auxiliary control signal G₁₀₂.

In the example of FIG. 2, the active clamp flyback converter 200 further comprises: a shutdown detection circuit 105, configured to detect a shutdown condition of the active clamp flyback converter 200, to generate a shutdown signal V_{SHD}. The control circuit 104 is configured to control the main power switch 101 to be turned on in response to the shutdown signal V_{SHD}, until a current flowing through the main power switch 101 reaches a main current limit. Then the control circuit 104 is configured to control the auxiliary switch 102 to be turned on and the main power switch 101 to be turned off, until a current flowing through the auxiliary switch 102 reaches a zero reference, to control the integrated circuit to enter a protection mode. In one embodiment of the present invention, the zero reference may have a value around zero.

In one embodiment of the present invention, the shutdown condition of the active clamp flyback converter 200 comprises at least one of the following conditions: the current flowing through the main power switch 101 reaches the main current limit (i.e., an over current condition at the main power switch 101), the current flowing through the auxiliary switch 102 reaches an auxiliary current limit (i.e., an over current condition at the auxiliary switch 102), the output voltage reaches a voltage threshold (i.e., an over voltage condition at the output voltage), a temperature of the integrated circuit reaches a temperature threshold (i.e., an over temperature condition at the integrated circuit), and when the integrated circuit is disabled (e.g., when an enable pin EN of the integrated circuit is pulled low). Thus, the shutdown detection circuit 105 may comprise a plurality of comparators, each configured to perform a comparison function, such as comparing the current (e.g. I₁₀₁) flowing through the main power switch 101 with the main current limit I_{LM}, comparing the current (e.g. I₁₀₂) flowing through the auxiliary switch 102 with the auxiliary current limit I_{LA}, comparing the output voltage V_{O} with the voltage threshold VTH, comparing the temperature T of the circuit with the temperature threshold T_{TH}, and etc.

In one embodiment of the present invention, the protection mode comprises: the active clamp flyback converter 200 enters burst mode (i.e., the main power switch 101 and the auxiliary switch 102 enter burst mode), or the integrated circuit is shut down.

In the example of FIG. 2, the active clamp flyback converter 200 further comprises: a diode, coupled to the secondary winding T2, to provide the output voltage V_{O}. In other embodiments of the present invention, the diode may be replaced by a controllable power switch (e.g. a synchronous rectifier), to improve the efficiency.

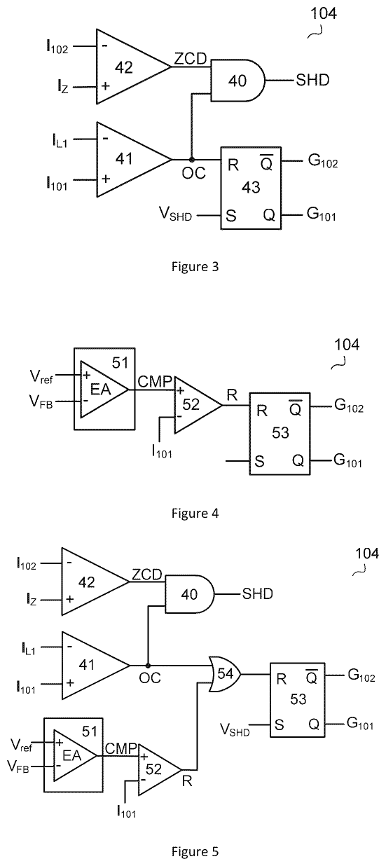

FIG. 3 schematically shows a circuit configuration of the control circuit 104 in accordance with an embodiment of the present invention. In the example of FIG. 3, the control circuit 104 comprises: a first comparator 41, a second comparator 42, a flip flop 43, and a logical circuit 40. The first comparator 41 is configured to compare a main sense signal I₁₀₁ indicative of the current flowing through the main power switch 101 with a main current limit I_{L1}, to generate an over current signal OC. The second comparator 42 is configured to compare an auxiliary sense signal I₁₀₂ indicative of the current flowing through the auxiliary switch 102 with a zero reference I_{Z}, to generate a zero detect signal ZCD. The flip flop 43 is configured to generate the main control signal G₁₀₁ and the auxiliary control signal G₁₀₂ in response to the shutdown signal V_{SHD} and the over current signal OC. Specifically, the flip flop 43 is configured to control the main power switch 101 to be turned on and the auxiliary switch 102 to be turned off in response to the shutdown signal V_{SHD}, and control the main power switch 101 to be turned off and the auxiliary switch 102 to be turned on in response to the over current signal OC. The logical circuit 40 is configured to generate a protection signal SHD in response to the over current signal OC and the zero detect signal ZCD, to have the integrated circuit enter the protection mode. In one embodiment of the present invention, the logical circuit 40 performs a logical AND operation on the over current signal OC and the zero detect signal ZCD, to generate the protection signal SHD.

FIG. 4 schematically shows a circuit configuration of the control circuit 104 in accordance with an embodiment of the present invention. As shown in FIG. 4, the control circuit 104 comprises: a PI (proportional integrated) circuit (e.g., an error amplifier EA) 51, a voltage comparator 52, and a flip flop 53. The proportional integrated circuit 51 is configured to amplify a difference of the feedback voltage V_{FB} and a reference voltage Vref, to generate a compensation signal CMP. The voltage comparator 52 is configured to compare the compensation signal CMP with the main sense signal 1101, to generate a reset signal R. The flip flop 53 is configured to generate the main control signal G₁₀₁ and the auxiliary control signal G₁₀₂ in response to the reset signal R, to respectively control the main power switch 101 and the auxiliary switch 102.

In one embodiment of the present invention, the flip flop 43 in FIG. 3 and the flip flop 53 in FIG. 4 may comprise a same RS trigger, as shown the control circuit 104 in FIG. 5. The control circuit 104 further comprises a logical OR circuit 54, configured to reset the RS trigger in response to the over current signal OC or the reset signal R. That is, the RS trigger is configured to generate the main control signal G₁₀₁ and the auxiliary control signal G₁₀₂ in response to the over current signal OC or the reset signal R, to control the main power switch 101 to be turned off, and the auxiliary switch 102 to be turned on.

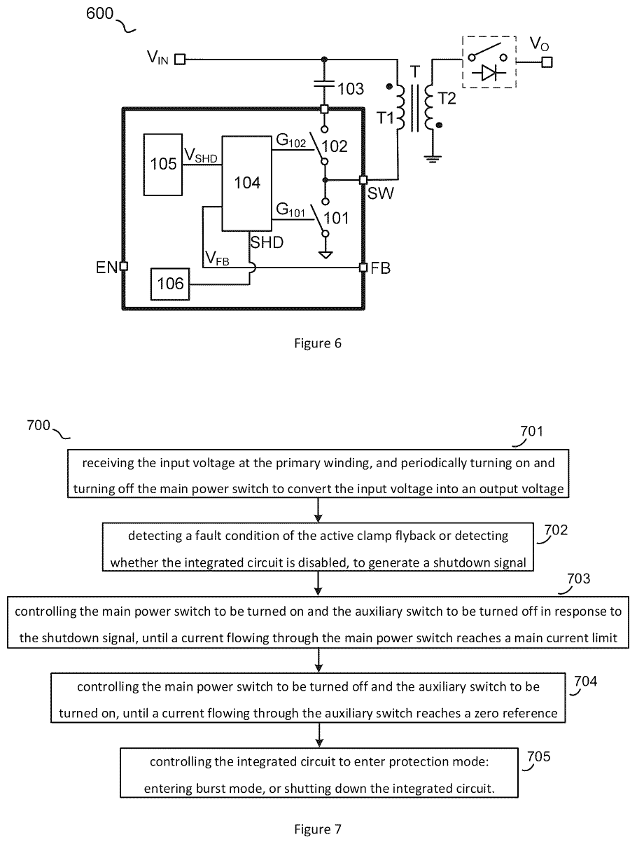

FIG. 6 schematically shows an active clamp flyback converter 600 in accordance with an embodiment of the present invention. The active clamp flyback converter 600 in FIG. 6 is similar to the active clamp flyback converter 200 in FIG. 2, with a difference that in the example of FIG. 6, the active clamp flyback converter 600 further comprises: a protection circuit 106, configured to have the active clamp flyback converter 600 enter the protection mode (e.g., burst mode, or shutdown the integrated circuit) in response to the protection signal SHD.

FIG. 7 schematically shows a flowchart 700 of a method used in an active clamp flyback converter in accordance with an embodiment of the present invention. The active clamp flyback converter comprises: a primary winding, a secondary winding, a main power switch coupled between the primary winding and a primary reference ground, an auxiliary switch and an auxiliary capacitor coupled in series between an input voltage and a switch node SW of the primary winding and the main power switch. The main power switch and the auxiliary switch is integrated at a same integrated circuit. The method comprises:

Step 701, receiving the input voltage at the primary winding, and periodically turning on and turning off the main power switch to convert the input voltage into an output voltage.

Step 702, detecting a fault condition of the active clamp flyback or detecting whether the integrated circuit is disabled, to generate a shutdown signal.

Step 703, controlling the main power switch to be turned on and the auxiliary switch to be turned off in response to the shutdown signal, until a current flowing through the main power switch reaches a main current limit.

Step 704, controlling the main power switch to be turned off and the auxiliary switch to be turned on, until a current flowing through the auxiliary switch reaches a zero reference.

Step 705, controlling the integrated circuit to enter protection mode: entering burst mode, or shutting down the integrated circuit.

In one embodiment of the present invention, the fault condition of the circuit comprises: the current flowing through the main power switch reaches the main current limit (i.e., an over current condition at the main power switch), the current flowing through the auxiliary switch reaches an auxiliary current limit (i.e., an over current condition at the auxiliary switch), the output voltage reaches a voltage threshold (i.e., an over voltage condition at the output voltage), a temperature of the circuit reaches a temperature threshold (i.e., an over temperature condition at the circuit), and etc.

Several embodiments of the foregoing active clamp flyback converter and the method force the main power switch to be turned on and the auxiliary power switch to be turned off when a fault condition happens, until the current flowing through the main power switch reaches the main current limit; then force the auxiliary switch to be turned on, and the main power switch to be turned off, until the current flowing through the auxiliary switch falls zero. Thus, substrate injection to the main power switch and the auxiliary switch is avoided, which protects the main power switch and the auxiliary switch.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. An active clamp flyback converter, comprising:
a transformer, including a primary winding configured to receive an input voltage, and a secondary winding configured to generate an output voltage;
a main power switch, coupled between the primary winding and a primary reference ground, wherein an electrical connection of the main power switch and the primary winding forms a switch node;
an auxiliary switch and an auxiliary capacitor, coupled in series between the switch node and the input voltage, wherein the main power switch and the auxiliary switch are integrated into a single integrated circuit;
a control circuit, configured to generate a main control signal and an auxiliary control signal in response to a feedback voltage indicative of the output voltage, to respectively control the main power switch and the auxiliary switch; and
a shutdown detection circuit, configured to detect a shutdown condition of the active clamp flyback converter, to generate a shutdown signal; wherein
the control circuit is configured to control the main power switch to be turned on and the auxiliary switch to be turned off in response to the shutdown signal, until a current flowing through the main power switch reaches a main current limit; and then the control circuit is configured to control the auxiliary switch to be turned on and the main power switch to be turned off, until a current flowing through the auxiliary switch reaches a zero reference, to control the integrated circuit to enter a protection mode.

2. The active clamp flyback converter of claim 1, wherein the control circuit comprises:
a first comparator, configured to compare a main sense signal indicative of the current flowing through the main power switch with the main current limit, to generate an over current signal;
a second comparator, configured to compare an auxiliary sense signal indicative of the current flowing through the auxiliary switch with the zero reference, to generate a zero detect signal;
a flip flop, configured to generate the main control signal and the auxiliary control signal in response to the shutdown signal and the over current signal; and
a logical circuit, configured to generate a protection signal in response to the over current signal and the zero detect signal, to have the integrated circuit enter the protection mode.

3. The active clamp flyback converter of claim 2, wherein the flip flop is configured to:
control the main power switch to be turned on and the auxiliary switch to be turned off in response to the shutdown signal; and
control the main power switch to be turned off and the auxiliary switch to be turned on in response to the over current signal.

4. The active clamp flyback converter of claim 2, further comprising:
a protection circuit, configured to have the integrated circuit enter the protection mode in response to the protection signal.

5. The active clamp flyback converter of claim 1, wherein the control circuit comprises:
a proportional integrated circuit, configured to amplify a difference of the feedback voltage and a reference voltage, to generate a compensation signal;
a voltage comparator, configured to compare the compensation signal with a main sense signal indicative of the current flowing through the main power switch, to generate a reset signal; and
a flip flop, configured to generate the main control signal and the auxiliary control signal in response to the reset signal, to respectively control the main power switch and the auxiliary switch.

6. The active clamp flyback converter of claim 1, wherein the shutdown condition of the active clamp flyback converter comprises at least one of:
the current flowing through the main power switch reaches the main current limit;
the current flowing through the auxiliary switch reaches an auxiliary current limit;
the output voltage reaches a voltage threshold;
a temperature of the integrated circuit reaches a temperature threshold; and
when the integrated circuit is disabled.

7. The active clamp flyback converter of claim 1, wherein the protection mode comprises:
the active clamp flyback converter enters burst mode, or the integrated circuit is shutdown.

8. An integrated circuit used for an active clamp flyback converter, comprising:
an auxiliary switch;
a main power switch, coupled between the auxiliary switch and a reference ground;
a control circuit, configured to generate a main control signal and an auxiliary control signal in response to a feedback voltage indicative of an output voltage of the active clamp flyback converter, to respectively control the main power switch and the auxiliary switch; and
a shutdown detection circuit, configured to detect a shutdown condition of the active clamp flyback converter, to generate a shutdown signal; wherein
the control circuit is configured to control the main power switch to be turned on and the auxiliary switch to be turned off in response to the shutdown signal, until a current flowing through the main power switch reaches a main current limit; and then the control circuit is configured to control the auxiliary switch to be turned on and the main power switch to be turned off, until a current flowing through the auxiliary switch reaches a zero reference, to control the integrated circuit to enter a protection mode.

9. The integrated circuit of claim 8, wherein the control circuit comprises:
a first comparator, configured to compare a main sense signal indicative of the current flowing through the main power switch with the main current limit, to generate an over current signal;
a second comparator, configured to compare an auxiliary sense signal indicative of the current flowing through the auxiliary switch with the zero reference, to generate a zero detect signal;
a flip flop, configured to generate the main control signal and the auxiliary control signal in response to the shutdown signal and the over current signal; and
a logical circuit, configured to generate a protection signal in response to the over current signal and the zero detect signal, to have the integrated circuit enter the protection mode.

10. The integrated circuit of claim 9, wherein the flip flop is configured to:
control the main power switch to be turned on and the auxiliary switch to be turned off in response to the shutdown signal; and
control the main power switch to be turned off and the auxiliary switch to be turned on in response to the over current signal.

11. The integrated circuit of claim 9, further comprising:
a protection circuit, configured to have the integrated circuit enter the protection mode in response to the protection signal.

12. The integrated circuit of claim 8, wherein the control circuit comprises:
a proportional integrated circuit, configured to amplify a difference of the feedback voltage and a reference voltage, to generate a compensation signal;
a voltage comparator, configured to compare the compensation signal with a main sense signal indicative of the current flowing through the main power switch, to generate a reset signal; and
a flip flop, configured to generate the main control signal and the auxiliary control signal in response to the reset signal, to respectively control the main power switch and the auxiliary switch.

13. The integrated circuit of claim 8, wherein the shutdown condition of the active clamp flyback converter comprises at least one of:
the current flowing through the main power switch reaches the main current limit;
the current flowing through the auxiliary switch reaches an auxiliary current limit;
the output voltage reaches a voltage threshold;
a temperature of the integrated circuit reaches a temperature threshold; and
when the integrated circuit is disabled.

14. The integrated circuit of claim 8, wherein the protection mode comprises:
the active clamp flyback converter enters burst mode, or the integrated circuit is shutdown.

15. A control circuit used in an active clamp flyback converter, the active clamp flyback converter including a main power switch and an auxiliary switch integrated at a single integrated circuit, the control circuit comprising:
a first comparator, configured to compare a main sense signal indicative of a current flowing through the main power switch with a main current limit, to generate an over current signal;
a second comparator, configured to compare an auxiliary sense signal indicative of a current flowing through the auxiliary switch with a zero reference, to generate a zero detect signal; and
a flip flop, configured to generate a main control signal and an auxiliary control signal in response to the over current signal and a shutdown signal indicative of a shutdown condition of the integrated circuit, wherein the flip flop is configured to:
control the main power switch to be turned on and the auxiliary switch to be turned off in response to the shutdown signal; and
control the main power switch to be turned off and the auxiliary switch to be turned on in response to the over current signal.

16. The control circuit of claim 15, further comprising:
a logical circuit, configured to generate a protection signal in response to the over current signal and the zero detect signal, to have the integrated circuit enter a protection mode.

17. The control circuit of claim 16, further comprising:
a protection circuit, configured to have the integrated circuit enter the protection mode in response to the protection signal.

18. The control circuit of claim 15, further comprising:
a PI circuit, configured to amplify a difference of a reference voltage and a feedback voltage indicative of an output voltage, to generate a compensation signal; and
a voltage comparator, configured to compare the compensation signal with the main sense signal, to generate a reset signal; wherein:
the flip flop is configured to generate the main control signal and the auxiliary control signal further in response to the reset signal, to respectively control the main power switch and the auxiliary switch.

19. The control circuit of claim 15, wherein the shutdown condition comprises at least one of:
the current flowing through the main power switch reaches the main current limit;
the current flowing through the auxiliary switch reaches an auxiliary current limit;
the output voltage reaches a voltage threshold;
a temperature of the integrated circuit reaches a temperature threshold; and
when the integrated circuit is disabled.

20. The control circuit of claim 15, wherein the protection mode comprises:
the main power switch and the auxiliary switch enter burst mode, or the integrated circuit is shutdown.
